(19) United States
(12) Patent Application Publication
(10) Pub. No.: US 2015/0169644 A1
(43) Pub. Date: Jun. 18, 2015

(54) Shape-Gain Sketches for Fast Image Similarity Search

(71) Applicant: Google Inc., Mountain View, CA (US)

(72) Inventors: Yunchao Gong, Carrboro, NC (US); Sanjiv Kumar, White Plains, NY (US); Henry Allan Rowley, Sunnyvale, CA (US)

(21) Appl. No.: 13/733,335

(22) Filed: Jan. 3, 2013

(51) Int. Cl. G06F 17/30

(52) U.S. Cl. CPC G06F 17/30277

(57) ABSTRACT

Separately optimizing angle error and magnitude error of a search query entered into a query database may be referred to as the “shape-gain” separation quantization. Each of a direction and a magnitude for each of a plurality of database vectors may be separately encoded. A query vector may be received. The query vector may include a query direction and a query magnitude. The separately encoded query direction, query magnitude, and each of the separately encoded direction and magnitude for each of the plurality of database vectors may be combined. Distances between the query vector and each of the plurality of database vectors may be determined. At least one of the plurality of database vectors that is similar to the query vector may be identified based on the determined distances.

### BACKGROUND

Efficiently searching and/or indexing large collections of content such as image data, video data, text data, can be challenging. Techniques such as Locality Sensitive Hashing (“LSH”) and its variants can be used to learn short binary hash codes to index large collections such as image data stored in a database. Although LSH-type methods can have a strong theoretical guarantee, they are mostly data independent and thus are not well-equipped to adapt to real data with relatively short codes. The vision and learning community has addressed the problem of learning binary hash codes that adapt to the data. But a fast and efficient method to learn binary hash codes that adapt to the data remains elusive.

The area of learning binary hash codes has received much attention with the goal of research aimed at learning short binary hash codes that preserve the neighbors of the original high dimensional feature vectors. Ideally, the learned codes would be short so as to fit in the memory of a workstation for efficient indexing. Also, the learned codes would, in the ideal case, accurately reflect the original nearest neighbors to provide high search accuracy. Beyond the known data-independent hashing methods, related areas include learning unsupervised binary codes, semi-supervised codes, supervised codes, and min-hash for high dimensional sparse data.

One approach to learning hash codes for visual retrieval related to spectral hashing. It proposed several approximations to the graph partition problem and generated codes from a graph. However, due to the aggressive approximations, such as uniform data distribution in feature space, such an approach does not fit real data distributions. Other approaches include using a non-orthogonal, relaxed principal component analysis (“PCA”) projection as the hash function to achieve improved performance. A rotational variant of PCA, which directly minimizes the quantization error, can produce better results when compared to the relaxed PCA projection. A structured learning framework for learning to hash has also been adapted to achieve “state-of-the-art performance” but it involves complicated parameter tuning. Also, a nonlinear hashing method without projection learning has been suggested that uses balls, instead of hyperplanes, to perform hashing. It achieved a performance improvement of a k-nearest neighbor search, as opposed to ε-nearest neighbor.

One observation about previous learning-based code generation methods is that the performance of nearest neighbor search stops to improve after 64 or 128 bits. Adding more bits to binary codes does not meaningfully improve the search performance after a certain point. This is, the amount of improvement approaches a ceiling.

### BRIEF SUMMARY

According to an implementation of the disclosed subject matter, each of a direction and a magnitude for each of a plurality of database vectors may be separately encoded. A query vector may be received. The query vector may include a query direction and a query magnitude. The separately encoded query direction, query magnitude, and each of the separately encoded direction and magnitude for each of the plurality of database vectors may be combined. Distances between the query vector and each of the plurality of database vectors may be determined based on the step of combining the separately encoded query direction, query magnitude, and each of the direction and magnitude for each of the plurality of database vectors. At least one of the plurality of database vectors that is similar to the query vector may be identified based on the determined distances.

Additional features, advantages, and implementations of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process flow according to an implementation disclosed herein.

### DETAILED DESCRIPTION

The disclosed subject matter can analyze the error in learning binary hash codes for a similarity search. Three errors can be introduced when converting data to binary hash codes and quantitatively analyzing them: magnitude error, angle error, and projection error. Magnitude error appears to be largely unaccounted for by previous work and this may have limited the performance of prior approaches. A framework for learning binary codes is proposed that separately optimizes each error. PCA appears adequate to compensate or account for projection error. To optimize the angle error, a modified iterative quantization (“ITQ”) approach can be implemented. An optimal scalar quantizer may be utilized as disclosed to achieve significantly better performance than previous methods. Separately optimizing angle error and magnitude error may be referred to as the “shape-gain” separation quantization. Different evaluation protocols are provided that can be used to demonstrate that some methods perform well for one protocol or one dataset (feature) but not necessarily for all others.

To fully understand the performance ceiling described earlier and overcome it, hashing quantization error can be analyzed in a way that categorizes the errors and presents quantitative analysis of the errors. Based on the error analysis, the underlying reason for the ceiling effect can be understood. A method in accordance with the disclosed subject matter is provided that achieves significant performance gains compared to the known methods. Implementations disclosed herein can relate to learning unsupervised binary codes that preserve the original nearest neighbors in an efficient manner.

Implementations are provided that learns compact image signatures for the purpose of a fast similarity search in a large image collection. Other signatures, such as video, audio, multimedia, text, language, or other forms of content, may also be analyzed according to any implementation disclosed herein. A “shape-gain independence” as used herein may refer to the assumption that the magnitude (e.g., gain) of each data point in a database, for example, can be independent of the angle (e.g., shape) between data points. A hashing method such as LSH, ITQ, or SSH may be adapted to hash the angle and scalar quantization (either fixed or adaptive quantization methods) may be utilized to quantize the magnitude and to generate “binary” signatures (e.g., binary image signatures). Additionally, the distance between such signatures may be efficiently computed.

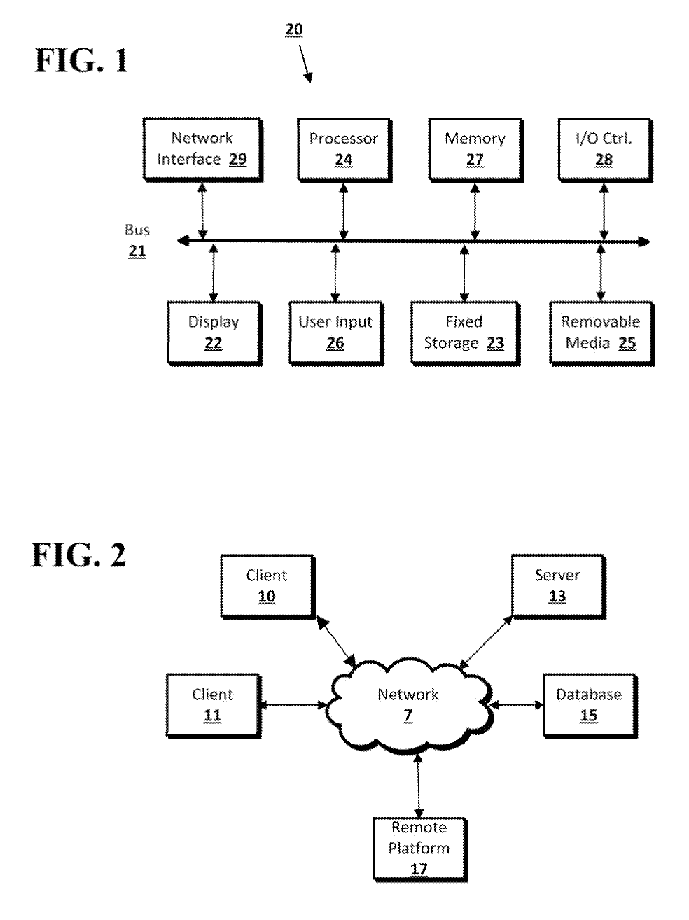

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

An analysis of a binary hash code error, that is, the error involved in converting data from real vectors to binary vectors, is provided. Converting a high-dimensional real valued vector x ∈ R^{d} to a low dimension binary code, b ∈ {+1,−1}^{C} can be problematic. In linear projection based code generation methods, typically the hash function defined by Equation 1 is used with zero-centered data.

b=sgn(xW) (Equation 1)

Thus, the hash function may describe projecting the data to low-dimensional space and applying a threshold to it to obtain a binary embedding. Generally, two errors are considered when using Equation 1: the projection error and the quantization error. The projection error may be related to the projection from high-dimensional space to low-dimensional space. The quantization error may refer to the sign operation that maps the data to a binary vertex. Quantizing the data from a real vector to binary vertices may introduce error. In particular, given the objective of error, the error may be directly minimized to obtain better codes. The projection error may be optimized by using a PCA projection, which preserves most variance of data. The quantization error may be directly formulated as minimizing the Euclidean distance between a set of rotated original vectors and their quantized binary vectors as:

∥bᵢ−xᵢR∥₂² (Equation 2)

However the formulation may be more restricted as the magnitude of each bᵢ is fixed. Thus directly considering the Euclidean distance between x and b might not be appropriate.

$$\begin{matrix}{‖ {b}_{i} - {x}_{i} R ‖}_{2}^{2} = ‖ {m}_{1} \hat{x} R - b ‖ \\ = {m}_{1}^{2} + 1 - 2 {x}^{T} {R}^{T} b \\ = {m}_{1}^{2} + 1 - 2 {m}_{1} {\hat{x}}^{T} {R}^{T} b ( Equation 4 ) \\ = {m}_{1}^{2} + 1 - 2 {m}_{1} cos ( θ )\end{matrix} \qquad ( Equation 3 )$$

where θ is the angle between \hat{x}R and b. Equations 3 and 4 may demonstrate parameterizing by R can handle the angle error as rotating the data by R can only reduce the angle between x and b, and increase cos (θ). Assuming by rotating the data, the rotated data become exact binary valued, which infers there are no error in the angle part (θ=0 and cos (θ)=1). A nonnegative error term may be obtained as follows:

m₁²+1−2m₁=(m₁−1)²≧0 (Equation 5)

Thus, rotating the data by R may not result in perfect quantization, except all the data vectors x are sampled on the unit ball which means ∥x∥₂²=1. The above term reduces to 0. For a real world dataset where data vectors may not be of equal length, the data vectors' binary quantization error can be greater than or equal Σᵢ^{N}(mᵢ−1)². This may suggest that rotating the data and minimizing quantization error may not be able to produce a code that can achieve perfect quantization. A problem arising from the magnitude error (m₁), which may become a constant term that cannot be reduced by R further. Rotating the data by R implicitly reduces the magnitude error as (m₁) also appears in the third term while the third term is not minimized during the learning.

The above discussion may suggest that this constant error might be the reason of the “ceiling” in previous experiments. This may be quantitatively verified in the following experiments. Assuming m₁ and θ are independent, the following errors may appear. Projection error (W) may result when projecting data from high dimensional space to a relatively low-dimensional space and may introduce a distortion of nearest neighbors. Angle error (θ) may refer to the distortion of the angle caused by rounding a point in the space to its nearest vertex. Magnitude error (m) may refer to a magnitude change caused by rounding a point to the nearest binary vertex. Except for data points on the unit sphere, all other points will have this error. Previous work considered the projection error and the distance error (which is composed by angle error and magnitude error). Considering these two errors separately, however, can be beneficial as described below.

The error of nearest neighbors from each of projection error, angle error, and magnitude error may be quantitatively evaluated. To evaluate the nearest neighbor accuracy, precision recall curves may be utilized as a protocol. First, the projection step's effect on nearest neighbor accuracy may be determined. PCA projections ranging from 32 to 320 dimensions may be used to show the precision recall curve. With more bits, the error introduced by PCA may be reduced, which is consistent with the earlier expressed concept that the leading directions contain most of the information. The error becomes or approaches 0 when 320 dimensions are used because the rotation of data does not change the Euclidean distance. However, a substantial amount of angle, and magnitude error exist in the ITQ. This suggests that ITQ may not completely preserve distance or that it loses information with respect to angle and magnitude. PCA embedding may be examined for mAP, mAP for normalized PCA embedding, and binarized PCA normalized plus ITQ rotation. After normalization, the PCA embedding provides a significant decrease in performance compared to the original PCA embedding. This indicates that without magnitude information, the performance of the real embedding is substantially decreased. After binarization, the PCA normalized plus ITQ provides slightly worse performance than an unbinarized version, which is the angle error. The use of additional bits permits more information to be captured or described, that is, the angle error decreases.

The above analysis demonstrates that an inadequate compensation for or consideration of magnitude is what may be responsible for the “ceiling.” Even for the real embedding, without magnitude information, the performance appears to be poor. Specifically, ITQ may approach the normalized PCA embedding which may explain the “ceiling effect.” A second implication of the above analysis is that to obtain adequate codes for data, each step should be optimized separately because each step introduces errors and they are approximately independent. For example, an improved projection method can be developed to better approximate k-nearest neighbors or ε-nearest neighbors and angle of data.

As disclosed herein, the basic assumption of shape-gain quantization is to assume the shape (the angle between points) and the gain (the magnitude of each data point) are independent. Assuming they are independent, the shape and gain of each data point may be separately quantized (or hashed). Assuming the shape and gain are indeed independent, then preserving the shape becomes preserving the angle between data points, and the gain is a scalar. Thus, scalar quantization schemes can be applied. In particular, each independent part may have less variation and quantizing each part may be easier than directly quantizing both.

The geometry of such quantization may be conceptualized as the gain being magnitude and shape being angle (data normalized to unit ball). Quantizing the magnitude may produce a set of circular cells that partitions the space and quantizing the angle may produce a set of partitions of the angle space. Combining both, they jointly define quantization cells of the full space, as shown below. The method can include centering the data matrix X to the origin, performing PCA to the centered data X, normalizing each embedded point to unit ball as \hat{X}, keeping the norm of each vector as v, hashing (\hat{X}) to a set of binary codes and quantizing (v) to a set of scalars.

Based on the above discussion, the data may be zero-centered and PCA may be performed to the data to reduce the dimensionality of the data. PCA has been shown to effectively generate low dimensional embedding while preserving the similarity between the data. Zero-centering is also important to produce balanced bits so as to maximize the use of each bit. For the embedded data, each point may be normalized to have unit norm as \hat{X} and the norm of each point may be maintained as v. \hat{X} and v may be separately quantized as described below.

To quantize shape, Charikar's LSH based on rounding algorithms may be utilized to preserve the angle between data points. This approach can be defined as follows:

bᵢ=H(x)=sgn(xW) (Equation 6)

where H(x) is the hash function, sgn is the sign function which maps data to ±1 by applying a threshold at 0, W is a matrix whose elements are drawn from a standard Gaussian. The generated binary codes preserve the angle between data points. Assuming two data points x and y and their angle θ, the following describes their relationship:

$$E ( cos ( π cos ( θ ) ) ) = {\sum }_{k = 1}^{m} ( \begin{matrix}m \\ k\end{matrix} ) \frac{{θ ( {π}^{k} - θ )}^{m - k}}{{1}^{m}} cos ( \frac{π k}{m} ) \qquad ( Equation 7 )$$

Equation 7 is upper bounded by θ and it is monotonically increasing with m. Thus, when an infinite number of random hyperplanes is used (m goes to infinity), the projected binary codes will exactly preserve the angle between the original points. The error of angle decreases quickly in the first several bits while the speed becomes very slow for relatively large m.

Instead of using data-independent random hyperplanes to approximate the angle between points, learning methods may be employed to find data-dependent angle hashing. In particular, a rotation of data may be determined such that after rotation, the angle between rotated data and the rounded binary point may be minimized (the cosine of angle is maximized).

$$\begin{matrix}Q ( B , R ) = {max}_{R} {\sum }_{i}^{N} cos ( {θ}_{i} ) \\ = {max}_{{b}_{i} , R} {\sum }_{i}^{N} {( \frac{{b}_{i}}{{‖ {b}_{i} ‖}_{2}} )}^{T} ( \frac{{v}_{i}}{{‖ {v}_{i} ‖}_{2}} R ) \\ = {max}_{{b}_{i} , R} \frac{1}{\sqrt{c}} tr ( {B}^{T} VR )\end{matrix} \qquad ( Equation 8 )$$

The following expression may directly maximize:

$$Q ( B , R ) = {max}_{B , R} \frac{1}{\sqrt{c}} tr ( {B}^{T} VR ) \\ s . t . B ∈ {\{ - 1 , + 1 \}}^{nxc} , {R}^{T} R = {RR}^{T} = I ) \qquad ( Equation 9 )$$

where V is the normalized PCA embedding. This is a well-known bilinear form which can be easily solved by alternating optimization.

B can be updated as follows. Each bᵢ can be optimized separately. Given rotated data v=vR, a threshold may be applied to obtains a binary code bᵢ for the data. The magnitude scalar quantizers may be used to determine its closest magnitude landmark. Multiplying bᵢ by mᵢ may result in the optimal solution.

R may be updated as follows. The optimal solution of R when B is fixed may be provided by polar decomposition of B^{T} V as USV=B^{T}V and let R=UV^{T}.

This approach, although similar to ITQ, completely differs from ITQ in the underlying geometry. In particular, ITQ attempts to directly minimize the Euclidean distance between rotated data and the quantized binary points, while the above approach attempts to rotate the data to minimize angle between rotated data and quantized points.

Gain (e.g., magnitude) may be quantized separately from angle. Because magnitude and angle are independent, magnitude error may be separately optimized. The magnitude is a scalar; thus, scalar quantization methods may be applied. Specifically, a set of k landmark points which minimizes the mean-squared error (“MSE”) distortion may be determined as follows:

minΣᵢⁿΣⱼ^{k}∥xᵢ−cⱼ∥₂² (Equation 10)

A k-means clustering may be employed to determine the optimal scalar quantization of the norms. First, the norms of projected training data may be collected. Second, a k-means clustering may be performed to the norms to k different clusters. This is equivalent to partitioning the space into k different levels. The value of the center may be recorded and log₂(k) bits may be utilized to encode the magnitude. In particular, using the k-means to find a near-optimal scalar quantization may produce the smallest distortion in terms of MSE error. Thus, the quantization of magnitude may also be optimal.

Next, a similarity estimation between sketches may be determined. The angle and magnitude may be indexed separately. In particular, for c₁-dimensional space, c₁ bits may be used to encode the angle and additional c₂ bits may be used to encode the magnitude. Thus the final learned code may have two parts—the angle code b₁ and the magnitude code b₂. Typically, b₁ is relatively large (e.g., more than 64 bits), and b₂ is usually very small (e.g., 2-4 bits). For example, a code may appear as follows: code=[+1, −1, −1, +1, +1, . . . ,+1, +1, −1, 0110]. In this example, the angles θ are represented by “[+1, −1, −1, +1, +1, . . . ,+1, +1, −1]” while the magnitude m is represented by “0110.” Two points may be considered a collision where both c₂ and c₂ are identical. A variety of techniques may be used to determine the distance between codes such as Hamming ranking or asymmetric distance as described below.

Hamming ranking directly computes the distance between a query and all database codes. Beginning with the Euclidean distance between query point q and database point d, each point can be decomposed to a binary code part and a magnitude part as q=m_{q}b_{q} and d=m_{d}b_{d} respectively. The distance between them can be computed by:

$$\begin{matrix}{‖ q - d ‖}_{2}^{2} = {‖ {m}_{q} {b}_{q} - {m}_{d} {b}_{d} ‖}_{2}^{2} \\ = {m}_{q}^{2} + {m}_{b}^{2} - 2 {m}_{q} {m}_{b} ( {b}_{q}^{T} {b}_{d} )\end{matrix} \qquad ( Equation 11 )$$

m_{q} does not need to be included because it belongs to the query side. Each m_{b}², can be found using a small 1×c₂ lookup table. 2m_{q}m_{b} can be found by a small 2^{c}^{₂}×2^{c}^{₂} lookup table. For b_{q}^{T}b_{d}, the elements are not from {0, 1}, but from {−1, +1} (i.e., this value may not be a Hamming distance). To obtain b_{q}^{T}b_{d}, the following equation may be utilized:

b_{q}^{T}b_{d}=c₁−2Hamming(b_{q,}b_{d}) (Equation 12)

Here Hamming (q,b) can be computed very fast by first performing xor to the bits together with bit count. This distance metric may require two additional operations (e.g., an addition and a multiplication). A comparison of running times between performing the computation with and without the two additional operations is described below. Briefly, the addition of these two operations does not appear to introduce a noticeable delay into the overall running time.

For retrieval, the query side does not need to be quantized to reduce quantization error at the query side. This concept may be combined with the model described herein to further improve the performance. Assume a query point q and a database point d, where q is not quantized and d has been quantized. To use asymmetric distance for retrieval, the computation of angle and magnitude may be separately determined:

$$\begin{matrix}{‖ q - d ‖}_{2}^{2} = {‖ {m}_{q} \tilde{q} - {m}_{d} {b}_{d} ‖}_{2}^{2} \\ = {m}_{q}^{2} + {m}_{b}^{2} - 2 {m}_{q} {m}_{b} ( \tilde{q} {b}_{d} )\end{matrix} \qquad ( Equation 11 )$$

where m_{q} and m_{q}m_{b} can be precomputed and stored as a lookup table. For the angle part \tilde{q}\tilde{q^{T}}b_{d}, it is no longer binary vector multiplication. Consequently, the Equation 12 cannot be applied.
The cost of pre-computing the lookup table a values may be negligible with respect to the cost of computing many (\tilde{q}\tilde{q^{T}}, d_{b}z)for a large amount of database items. Dimensions may be grouped into b=8 or more blocks (b is usually limited to an amount smaller than 32 due to memory demand for lookup tables), and construct a 1×2^{b} dimensional lookup table per block to perform the distance computation efficiently. This can reduce the number of summations and number of lookups and thereby improve speed for roughly b fold. For Hamming distance, using an Intel SSE 4.2 protocol, 64 bits together may be grouped together and xor and POPCNT operations may be performed. These operations typically increase the speed of the process by more than 64 times. Thus, the acceleration of asymmetric distance computations may not be as significant as that of

To demonstrate an embodiment of the disclosed subject matter, three large image datasets were used. The first dataset is the CIFAR10 dataset that contains 60,000 Internet images resized to 32×32 pixel tiny images. Each image may be represented using a 320-dimensional GIST descriptor. The second dataset is the SUN natural scene image dataset that contains 140,000 images. The images may be represented using a 1000-dimensional bag of words (“BoW') feature. Each BoW may be power normalized and L1 normalized. The third, and largest, dataset is from Tiny images. 0.5 million noisy web images were sampled. The 320-dimensional GIST descriptor was used to represent the images.

Typically, a method is evaluated using one specific protocol (e.g., either ε- or k-nearest neighbors). Such an approach risks over-fitting the method to one protocol. A method that performs well for one protocol may still be useful. But comprehensively evaluating a method using several different protocols is more desirable. The disclosed methods are evaluated below using several different protocols described below.

ε-nearest neighbors protocol has been used to evaluate how the learned codes approximates the original distance. For a set of query points, a set of ground truth neighbors may be defined within a radius ε. For the learned codes, a precision recall curve with a different Hamming radius may be obtained. This mainly evaluates how well matched the original distribution and the distribution of binary codes. k-nearest neighbors protocol may define a ground truth to each query. This ground truth definition may not exactly reflect the actual data distribution. For example, for one query in a very dense area will have many neighbors while a point in sparse area may not have any neighbors. The true rank vs. expected rank may rank the close neighbors higher than faraway neighbors in binary space.

LSH uses a random Gaussian matrix to generate binary codes for zero-centered data. Spectral hashing (“SH”) quantizes the values of analytical eigenfunctions computed along PCA directions of the data. Shift-invariant Kernels LSH (“SKLSH”) is based on the random features mapping for approximating shift-invariant kernels. This method may outperform SH for code sizes larger than 64 bits. A Gaussian kernel may be used with the bandwidth set to the average distance to the 50th nearest neighbor. PCA-ITQ learns a rotation of PCA projected data to minimize squared distance. Spherical hashing (“SPH”) uses hypersphere instead of hyperplane to generate binary codes. Product quantization (“PQ”) may provide superior results for nearest neighbors search. PQ is essentially not a binary coding scheme as it needs to be coupled with a distance lookup table. Thus, the distance computation will be slower than Hamming (by using the hardware efficient xor and popcount). Due to its excellent performance it has been included in the experiments detailed below. A PCA may be performed first to reduce the dimensionality to c followed by a random rotation to balance the variance. Next, eight dimensions may be grouped together and may learn 256 clusters per group, which generates c bits. Empirically, 8 dimensions per group consistently led to the optimal performance for the experiments described below.

The effect of each optimization step (e.g., each error) may be examined to ascertain how, if at all, it may improve performance. Different projection methods may be compared for preserving nearest neighbors. Surprisingly, using locality preserving projections or nonlinear kernel PCA (“KPCA”) does not necessarily improve the embedding for nearest neighbors search it may impede performance. These methods may preserve the manifold structure and introduce some distortion to the embedding process. The effect of reducing angle error may be examined. Using the learned rotation may effectively reduce the angle error. The magnitude error may be examined as well. Few bits may be needed to encode the magnitude. In particular, 3-4 bits (8-16 different levels) may provide sufficient performance for many applications. Thus, 3-4 bits may be used to encode magnitude in addition to the bits needed to encode the angle.

The above-mentioned evaluation protocols may be applied to the CIFAR dataset. The approach disclosed herein consistently performed better than all other methods for all three evaluation protocols. By combining the asymmetric distance with the proposed approach, an additional 10% improvement of performance may be achieved. SPH's performance appears best tuned for k-nearest neighbors search. For ε-nearest neighbors search, SPH's performance was adequate, but slightly worse than that of ITQ. SKLSH's performance was poor for relatively short bits and when the number of bits is increased, its performance may improve. However, even for 320 bits, SKLSH still yields substantially worse performance than the disclosed approach likely because there are two randomized terms (random projection and random bias term) whose concentration speed may be much slower than the learned codes that directly optimize the error. The evaluation suggests that one method may perform well for one protocol but have inferior performance on another protocol.

Next, the evaluation protocols may be used to examine the SUN dataset. The image representation for SUN is BoW, instead of GIST. The method in accordance with the disclosed implementation performed better than other baseline methods and the asymmetric distance version achieves even better performance than the proposed method by itself. ITQ and LSH type methods perform poorly on the SUN dataset because the magnitude plays a more important role for this dataset than the CIFAR10 dataset. Ignoring the magnitude results in a significant loss of information. The SPH approach does not suffer from the magnitude loss because it directly uses balls as a hash function.

As a third evaluation protocol, the results for Recall@p for k-NN search are provided. The ground truth neighbors may be defined as five nearest neighbors. PQ performs better than previous results indicating that it might be better at preserving local neighborhoods, but it might not be very good at preserving global neighborhood structure. The method in accordance with the disclosed subject matter with asymmetric distance significantly outperforms all other methods. The symmetric version performs comparably to PQ ASD and it significantly outperforms the symmetric distance version of PQ, which convincingly demonstrated the superiority of the disclosed method. The disclosed approach may be better than PQ because the whole data distribution is utilized as a whole and directly optimized for high accuracy. In contrast, PQ partitions the dimensions into many segments. Thus, the global optimality over the whole dimensions is not guaranteed.

As an example, the expected rank vs. true rank may be analyzed for 128 bits code. The results are consistent with previous experiments and indicate that the proposed approach leads to large improvement over other methods.

The timing of retrieval may also be determined by, for example, comparing the speed of Hamming distance and our proposed distance. For Hamming distance computation, 64 bits may be grouped together as an integer and a xor and a popcount may be performed. All of the values may be summed. The disclosed method adds one addition and one multiplication operation. To compare symmetric with asymmetric distance, eight bits may be grouped together and a lookup table may be constructed. Table look-ups may be performed eight bits by eight bits. The speed for 256 bits on 1 million database images may be compared and are provided in Table 1. The additional two operations did not necessarily add more running time. The retrieval time of the disclosed method may be similar to other look-up methods as shown in Table 1.

TABLE 1

| | Method | | | | |
|---|---|---|---|---|---|
| | Hamming | Disclosed | Hamming | Disclosed | Asymmetric |
| | distance, | method, | Look-up, | method, | Look-up, |
| | 64 bits | 64 bits | 8 bits | 8 bits | 8 bits |
| 256 bits | 6.1 | 7.4 | 44.2 | 46.8 | 49.1 |

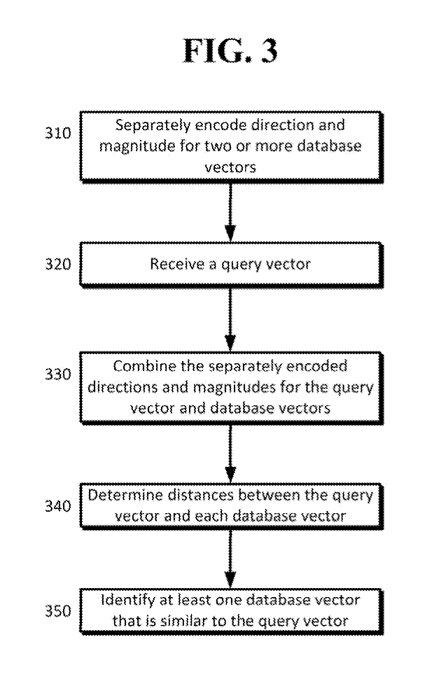

In accordance with the disclosed subject matter, each of a direction and a magnitude can be encoded for each of a plurality of database vectors at 310 as shown in FIG. 3. The encoding can be a binary encoding.

A query vector having a query direction and a query magnitude can be received at 320. The query vector can be derived from or based upon an image, a video, a textual input, an audio input or upon one or more elements of any other type of data. The direction and a magnitude of the query vector can be separately encoded. The direction and magnitude can correspond to features or attributes of searchable data. For example, a given query vector may be based on attributes of a pixel or set of pixels in an image, such as location, color, intensity, brightness, grayscale, size and the like.

The separately encoded query direction, query magnitude, and each of the separately encoded direction and magnitude for each of the database vectors can be combined at 330. The combining can include precomputing certain products to speed later calculations and lookups, as described below.

Distances can be determined between the query vector and each of the database vectors based on the combined separately encoded query direction, query magnitude, and each of the direction and magnitude for each of the plurality of database vectors at 340. The distance can be based upon the angle between the query vector and at least one of the plurality of database vectors.

At least one of the plurality of database vectors can be identified that is similar to the query vector based on the determined distances at 350. The database vectors that are identified as being similar to the query vector can be ranked in terms of that similarity. For example, a database vector determined to be a smaller distance from the query vector can be ranked higher (more similar to the query vector) than other, more distance database vector. Likewise, the data corresponding to a closer database vector can be returned with a higher rank or position by a search engine responding to a query based on data corresponding to the query vector. In some configurations, the identified at least one of the plurality of database vectors may be ranked according to similarity to the query vector.

Further in accordance with the disclosed subject matter, a covariance matrix for at least some of the plurality of database vectors can be determined. At least one eigenvector can be determined for the at least one or more of the database vectors based on the covariance matrix. The at least one eigenvector can span a space. At least some of the database vectors can be projected on the space spanned by the at least one eigenvector. The projected database vectors can be rotated. The rotation can be random or pseudorandom. The rotation can be structured to minimize an average difference of the angle between each of the database vectors and its corresponding encoded direction. A threshold can be applied to the rotated projected database vectors to obtain an encoding of the directions of the at least some of the database vectors.

A k-means clustering can be performed with respect to the magnitudes of the database vectors. The centers can be selected to minimize the sums of the distances between each of the magnitudes of the database vectors and the nearest k-means center of the each of the magnitudes of the database vectors. Each k-means center can correspond to a magnitude and a square of the k-means center magnitudes can be precomputed. A database vector magnitude can be associated with a k-means center magnitude. The products of the query magnitudes and the precomputed k-means center magnitudes can be combined and precomputed.

Other tables may be precomputed. A magnitude look-up table can be generated based on a combination of the magnitudes of the database vectors and the query vector. An angle look-up table can be precomputed based on the angle between the database vectors and the query vector. The distance between the query vector and a database vector can be determined using the precomputed magnitude look-up table and the precomputed angle look-up table. The query vector can be quantized and the precomputed magnitude and angle look-up can be globally valid for any query vector.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method, comprising:
identifying, for each of a plurality of portions of an image, a vector having a direction representing a visual aspect of the portion of the image, the vector also having a magnitude representing a position of the visual aspect within the image;
for each portion of the image, separately encoding each of the direction and the magnitude of the vector corresponding to the portion of the image to create a separately encoded direction and a separately encoded magnitude for the portion of the image;
receiving a query vector representing a query image, wherein the query vector comprises a query direction representing a visual aspect of a portion of the query image and a query magnitude representing a position of the visual aspect in the query image;
combining the separately encoded direction and magnitude for each of multiple portions of the image;
determining one or more distances between the query vector and the vectors of the image based on the query vector, and the combination of the separately encoded direction and magnitude for the multiple portions of the image; and
determining that at least one of the vectors of the image is similar to the query vector based on the determined one or more distances.

2. The method of claim 1, wherein the encoding comprises a binary encoding.

3. (canceled)

4. The method of claim 1, wherein determining distances comprises determining an angle between the query vector and at least one of the plurality of vectors.

5. The method of claim 1, wherein the query vector corresponds to at least one from the group consisting of an image, a video, a textual input and an audio input.

6. The method of claim 1, further comprising:
determining a covariance matrix for the vector;
determining at least one eigenvector for the vector based on the covariance matrix, the at least one eigenvector spanning a space;
projecting the vector on the space spanned by the at least one eigenvector;
rotating the projected vector; and
applying a threshold to the rotated vector to obtain an encoding of the vector.

7. The method of claim 6, wherein the rotating the vector comprises a random rotation.

8. The method of claim 6, wherein the rotating the vector comprises a rotation that minimizes an average difference of the angle between vector and its corresponding encoded direction.

9. The method of claim 1, further comprising k-means clustering the magnitude of the vector and magnitudes of other vectors, wherein a plurality of centers are selected to minimize sums of distances between each of the magnitudes of the vectors and a nearest k-means center.

10. The method of claim 9, wherein each k-means center corresponds to a magnitude and further comprising precomputing a square of the k-means center magnitudes and associating a vector magnitude with a k-means center magnitude.

11. The method of claim 10, further comprising precomputing a product of the query magnitude and the precomputed k-means center magnitudes.

12. The method of claim 10, further comprising:
generating at least one precomputed magnitude look-up table based on the magnitudes of the vectors and the query vector; and
generating a precomputed angle look-up table based on an angle between the vectors and the query vector.

13. The method of claim 12, further comprising:
determining a distance between the query vector and one of the vectors using the at least one precomputed magnitude look-up table and the precomputed angle look-up table.

14. The method of claim 13, wherein the query vector is quantized and the at least one precomputed magnitude look-up table and the precomputed angle look-up table are globally valid for any query vector.

15. The method of claim 13, wherein the query vector is not quantized and the at least one precomputed magnitude look-up table and the precomputed angle look-up table are generated for each query vector.

16. (canceled)

17. The method of claim 1, wherein the magnitude of the query vector corresponds to an attribute of at least one pixel in an image.

18. The method of claim 17, wherein the attribute is selected from the group consisting of: a color, an intensity, a brightness, a grayscale, and a size.

19. The method of claim 1, further comprising ranking the vector according to similarity to the query vector.
